(19) United States
(12) Patent Application Publication
(10) Pub. No.: US 2023/0293992 A1
(43) Pub. Date: Sep. 21, 2023

(54) GAME REPLAY CONTROL METHOD AND APPARATUS, DEVICE, AND STORAGE MEDIUM

(71) Applicant: NETEASE (HANGZHOU) NETWORK CO., LTD., Hangzhou (CN)

(72) Inventor: Zequan ZHANG, Hangzhou (CN)

(73) Assignee: NETEASE (HANGZHOU) NETWORK CO., LTD., Hangzhou (CN)

(21) Appl. No.: 18/321,813

(22) Filed: May 23, 2023

Related U.S. Application Data
(63) Continuation of application No. PCT/CN2021/071844, filed on Jan. 14, 2021.

(30) Foreign Application Priority Data
Nov. 23, 2020 (CN) 202011325219.0

(51) Int. Cl. A63F 13/497; A63F 13/533; A63F 13/67

(52) U.S. Cl. CPC A63F 13/497; A63F 13/533; A63F 13/67

(57) ABSTRACT

A game replay control method includes: determining, in response to a preset selection operation of a player on a game playback interface, a game replay start time and a target replay character; switching, the game playback interface to a game competition interface, and restoring, based on pre-stored historical game data, a game scene corresponding to the game replay start time; controlling, in response to a control operation input on the game competition interface, a game behavior of the target replay character, and controlling, based on preset game logic, a game behavior of a first virtual character different from the target replay character.

### CROSS-REFERENCE TO RELATED APPLICATIONS

The present application is a continuation of International Application No. PCT/CN2021/071844, filed on Jan. 14, 2021, which is based upon and claims the priority to the Chinese Patent Application No. 202011325219.0, entitled “GAME REPLAY CONTROL METHOD AND APPARATUS, DEVICE, AND STORAGE MEDIUM”, filed on Nov. 23, 2020, and the entire contents of both of which are hereby incorporated by reference for all purposes.

### TECHNICAL FIELD

The present disclosure relates to the technical field of games, and in particular, to a game replay control method and apparatus, device, and storage medium.

### BACKGROUND

In most online games, such as multiplayer battle arenas, a player is supported to watch the playback of the competition in any view after the competition when all the data of the competition has been stored to the server. When the player watches the playback of the competition, there is a need for him to replay the competition at a certain moment. For example, if a player is defeated at a certain point of time, he wants to replay the competition at this moment to train his reactions and operations in the next time he faces the same scenario.

The existing games only support the playback of the game competition. There is no effective solution for how to achieve replay during the playback.

### SUMMARY

In a first aspect, the present disclosure provides a game replay control method, including:
determining, in response to a preset selection operation of a player on a game playback interface, a game replay start time and a target replay character, where a graphical user interface is provided on a display of a terminal, the game playback interface is displayed on the graphical user interface, and the game playback interface is configured for playing back a corresponding gameplay footage based on pre-stored historical game data;
switching the game playback interface to a game competition interface, and restoring, based on the pre-stored historical game data, a game scene corresponding to the game replay start time on the game competition interface; and
controlling, in response to a target replay character control operation input on the game competition interface, a game behavior of the target replay character, and controlling, based on preset game logic, a game behavior of a first virtual character, where the first virtual character is different from the target replay character.

In a second aspect, the present disclosure provides a terminal device, including: a display, a processor, a storage medium and a bus, where the storage medium stores machine-readable instructions executable by the processor, and when the terminal device is running, the processor communicates with the storage medium via the bus, and the processor, through executing the machine-readable instructions, is configured to: determine, in response to a preset selection operation of a player on a game playback interface, a game replay start time and a target replay character, where a graphical user interface is provided on the display, the game playback interface is displayed on the graphical user interface, and the game playback interface is configured for playing back a corresponding gameplay footage based on pre-stored historical game data; switch the game playback interface to a game competition interface, and restore, based on the pre-stored historical game data, a game scene corresponding to the game replay start time on the game competition interface; and control, in response to a control operation input on the game competition interface, a game behavior of the target replay character, and control, based on preset game logic, a game behavior of a first virtual character, where the first virtual character is different from the target replay character.

In a third aspect, the present disclosure provides a non-transitory computer-readable storage medium, where the storage medium stores a computer program, and the computer program, when executed by a processor, executes steps of the game replay control method according to the first aspect.

### BRIEF DESCRIPTION OF THE DRAWINGS

In order to more clearly illustrate the technical solutions of the embodiments of the present disclosure, the accompanying drawings required for use in the embodiments are briefly described below. It should be understood that the following accompanying drawings illustrate only certain embodiments of the present disclosure and therefore should not be regarded as limiting the scope. For those ordinary skilled in the art, other relevant accompanying drawings may be obtained from these drawings without creative effort.

FIG. 1 is a schematic flowchart of a game replay control method provided by one or more embodiments of the present disclosure.

FIG. 2 is a schematic flowchart of another game replay control method provided by one or more embodiments of the present disclosure.

FIG. 3 is a schematic flowchart of yet another game replay control method provided by one or more embodiments of the present disclosure.

FIG. 4 is a schematic diagram of a graphical user interface provided by one or more embodiments of the present disclosure.

FIG. 5 is a schematic flowchart of another game replay control method provided by one or more embodiments of the present disclosure.

FIG. 6 is a schematic diagram of another graphical user interface provided by one or more embodiments of the present disclosure.

FIG. 7 is a schematic diagram of a game replay control apparatus provided by one or more embodiments of the present disclosure.

FIG. 8 is a schematic structure diagram of a terminal device provided by one or more embodiments of the present disclosure.

### DETAILED DESCRIPTION

In order to make the purpose, technical solutions and advantages of the embodiments of the present disclosure clearer, the technical solutions in the embodiments of the present disclosure will be clearly and completely described below in conjunction with the accompanying drawings in the embodiments of the present disclosure. It should be understood that the accompanying drawings in the present disclosure serve only illustrative and descriptive purposes and are not intended to limit the protection scope of the present disclosure. Further, it should be understood that the schematic accompanying drawings are not drawn to physical scale. The flowcharts used in the present disclosure illustrate operations implemented according to some embodiments of the present disclosure. It should be understood that the operations of the flowcharts may be implemented out of sequence, and steps that have no logical contextual relationship may be reversed in order or implemented simultaneously. In addition, guided by the present disclosure, those skilled in the art may add one or more other operations to the flowchart and may remove one or more operations from the flowchart.

In addition, the described embodiments are only a portion of the embodiments of the present disclosure, and not all of them. The components of the embodiments of the present disclosure generally described and illustrated in the accompanying drawings herein may be arranged and designed in a variety of different configurations. Accordingly, the following detailed description of the embodiments of the present disclosure provided in the accompanying drawings is not intended to limit the scope of the claimed protection in the present disclosure, but rather indicates only the selected embodiments of the present disclosure. Based on the embodiments of the present disclosure, all other embodiments obtained without creative labor by those skilled in the art are within the protection scope of the present disclosure.

It should be noted that the term “include” will be used in the embodiments of the present disclosure to indicate the existence of the features subsequently declared, but does not preclude the addition of other features.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The present disclosure provides a game replay control method and apparatus, device, and storage medium, so as to facilitate solving the problem of not being able to achieve the game replay according to the player's wishes during the gameplay.

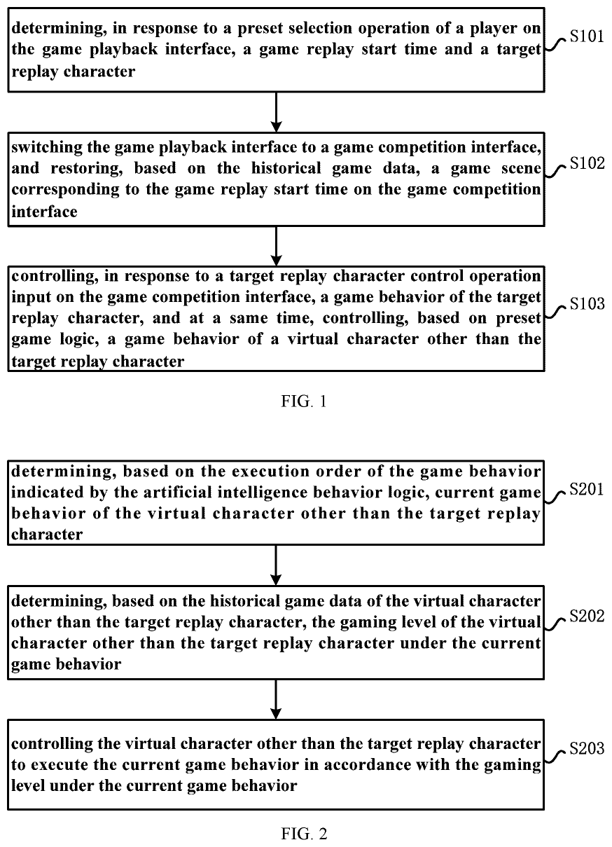

FIG. 1 is a schematic flowchart of a game replay control method provided by the embodiments of the present disclosure. The execution subject of the method may be a terminal running a target game. A graphical user interface is provided on a display of the terminal, a game playback interface is displayed on the graphical user interface, and the game playback interface is used for playing back a corresponding gameplay footage based on pre-stored historical game data.

In order to enable the player to input a game replay instruction on different functional controls on the game playback interface to switch the game playback interface to the game competition interface to achieve game replay during the playback of the game, controls with different functions, such as a virtual character selection control, a game time selection control, a game replay determination control, etc., may be included on the game playback interface.

In this embodiment, the pre-stored historical game data may be the competition data recorded by the server at the backend of the terminal during the formal game competition of the player, or the competition data directly stored locally in the terminal. The pre-stored historical game data may be the competition data obtained and recorded in real-time, or the competition data obtained and recorded under the control of a non-real-time instruction.

To achieve the playback of the complete game competition footage or the playback of a part of the game competition footage of the target game, the game footage played back on the game playback interface may be a gameplay footage generated based on complete competition data of the target game obtained from a large amount of competition data recorded by the server at the backend of the terminal or recorded locally in the terminal, or may be a part of the gameplay footage generated based on a part of the competition data of the target game obtained from a large amount of competition data recorded by the server at the backend of the terminal or recorded locally in the terminal. As shown in FIG. 1, the method of the present disclosure may include the following steps S101˜S103.

In step S101, a game replay start time and a target replay character are determined in response to a preset selection operation of a player on the game playback interface.

After the player has experienced a wonderful game competition, watching the gameplay through the playback can effectively help the player to observe the details of the game more comprehensively, so as to find and analyze his deficiencies in the game and improve accordingly. The achievement of the replay of the game during the playback of the game can train the reactions and operations of the play under certain specific situations, which can help the player to achieve better results in the subsequent competitions.

When the player is playing back a game competition, the player may perform a preset selection operation on the game playback interface, and the game replay start time and the target replay character that the player wants to replay are determined in response to the preset selection operation of the player.

The preset selection operation may be triggered by detecting a touch operation on a specific trigger control provided on the game playback interface displayed on the graphical user interface, or may be triggered based on a preset interaction condition, e.g., a user press, a double click, shaking, sound input and other means.

Usually, there are a plurality of virtual characters in one game competition, and the player may select the virtual character he is interested in and replay by selecting the virtual character he is interested in as the target replay character. Moreover, the entire process of the game competition is not always wonderful, and for some ordinary game segments that do not have much significance for replaying, the player may skip replaying and freely choose the game time they want to replay. Through the preset selection operation input by the player on the game playback interface, the determination of the target replay character and the game replay start time may be achieved, thereby achieving targeted game replay according to the preference of the player.

In step S102, the game playback interface is switched to a game competition interface, and a game scene corresponding to the game replay start time on the game competition interface is restored based on the historical game data.

When the target replay character and the game replay start time are determined, the game playback interface may be switched to the game competition interface, and the game scene of the replayed game may be displayed on the game competition interface.

The stored competition data of the game at the game replay start time may be retrieved from the server at the backend of the terminal based on the game replay start time determined by the player, and the game scene of the game replay start time may be generated and displayed on the game competition interface based on the competition data. In some embodiments, in order to accurately restore the game scene, the positions and states of each virtual character in the game scene corresponding to the game replay start time obtained from the restoration are the same as the positions and states of the virtual characters at that moment in the historical game competition.

In step S103, a game behavior of the target replay character is controlled in response to a target replay character control operation input on the game competition interface, and at a same time, a game behavior of a virtual character other than the target replay character is controlled based on preset game logic.

Since it is a replay of the battle process of the selected target replay character in the game scene, the player may input a control operation for the selected target replay character on the game competition interface. The control operation may be different from the control operation of the target replay character in the previous historical competition, and may be a better battle pattern determined based on the analysis of the battle process of the target replay character in the historical competition. The game behavior of the controlled target replay character may be displayed on the game competition interface in response to the control operation for the target replay character input by the player.

In some examples, the determined target replay character may be a virtual character previously controlled by the player in the game via his own terminal, a virtual character controlled by a game teammate of the player in the game, or, alternatively, a virtual character controlled by an enemy that interacts with the virtual character controlled by the player in the game. Thus, the player can review the game operation of any virtual character in the target game to experience the game effect brought by the game operation for different virtual characters, and to find the control gap and deficiencies of different virtual characters.

A preset game logic is used for the control of the game behavior of a virtual character other than the selected target replay character in the method. The number of the virtual character other than the target replay character may vary depending on the type of the game, herein, the virtual character other than the target replay character is the virtual character that interacts with the target replay character in the game or the virtual character that belongs to the same team as the target replay character. Regardless of the number of the virtual characters other than the target replay character, the preset game logic may be used for control. The preset game logic may be game logic generated based on the historical game data of the virtual character other than the target replay character. The historical game data may include: a game behavior, gaming level corresponding to the game behavior, etc. Thereby, the gaming level of the virtual character other than the target replay character can be more realistically restored, and the game interaction between the target replay character and the virtual character other than the target replay character can be realized, so that the player can train under a specific game situation and improve his reaction ability and operation ability for the game.

In summary, the game replay control method provided in this embodiment includes: determining, in response to a preset selection operation of a player on the game playback interface, a game replay start time and a target replay character; switching the game playback interface to a game competition interface, and restoring, based on the historical game data, a game scene corresponding to the game replay start time on the game competition interface; and controlling, in response to a target replay character control operation input on the game competition interface, a game behavior of the target replay character, and at a same time, controlling, based on preset game logic, a game behavior of a virtual character other than the target replay character. According to the examples in the present disclosure, the game scene of the target replay character at the game replay start time can be restored in response to the preset selection operation input by the player on the game playback interface, herein, the target replay character is selected by the player, and in response to the control operation input by the player for the target replay character, the game behavior of the target replay character can be controlled in the restored game scene, thereby achieving the game replay. Through the preset selection operation input by the player, the player can replay, in a targeted manner, the game scene and the game character that he is interested in, improving the gaming experience of the player. In addition, during the replay process, by controlling the game behavior of the virtual character other than the target replay character based on the preset game logic, the gaming level of the virtual character other than the target replay character in the historical game competition can be more realistically restored, allowing the player to train the character's reaction ability and operation ability in a specific situation during the replay process of the target replay character, which can help the player to improve the deficiencies and achieve better results in the subsequent gameplay.

In some examples, in step S103, the preset game logic is artificial intelligence behavior logic, and the artificial intelligence behavior logic is used for controlling an execution order of the game behavior of the virtual character other than the target replay character and gaming level of the virtual character other than the target replay character when executing the game behavior.

In this embodiment, the preset game logic may be artificial intelligence (AI) behavior logic. Herein, the preset game logic may include an intelligent control model. The intelligent control model may be obtained by training based on historical competition data of game characters in a large amount of historical game data, and the preset game logic may be implemented based on the intelligent control model. In the control of the game behavior of the virtual character other than the target replay character based on the preset game logic, the acquired competition data of the virtual character other than the target replay character in the replayed game may be used as an input to the intelligent control model, thereby achieving in a simulative manner the intelligent control of the virtual character other than the target replay character, and controlling the execution order of the game behavior of the virtual character other than the target replay character in the game replay process and the gaming level corresponding to each step of the game behavior of the virtual character other than the target replay character in the game replay process.

For example, the game behavior includes: sprinting, punching, shooting, etc. According to the logic of the historical game behavior of the virtual character other than the target replay character in the game competition, the execution order of the game behavior of the virtual character during the replay may be determined to be: sprinting-shooting-sprinting-punching. And the speed, shooting accuracy, punching strength and other gaming levels when the virtual character is sprinting may be determined. Thus, the game behavior of the virtual character other than the target replay character can be controlled.

In some embodiments, the AI behavior logic may be an AI logic control tree. Each node in the AI logic control tree is used for characterizing the entire behavior logic of the game AI of any virtual character other than the target replay character. The execution order and gaming level of the AI behavior logic may be obtained by sequentially traversing the AI logic control tree.

FIG. 2 is a schematic flowchart of another game replay control method provided by the embodiments of the present disclosure. As shown in FIG. 2, in the step S103 described above, the controlling, based on the preset game logic, the game behavior of the virtual character other than the target replay character includes the following steps S201˜S203.

In step S201, current game behavior of the virtual character other than the target replay character is determined based on the execution order of the game behavior indicated by the artificial intelligence behavior logic.

In some examples, the artificial intelligence behavior logic includes the execution order of the game behavior of the virtual character other than the target replay character and the gaming level at which each game behavior is executed. By invoking the artificial intelligence behavior logic, the current game behavior of the virtual character other than the target replay character may be determined based on the execution order of the game behavior included in the artificial intelligence behavior logic.

In step S202, the gaming level of the virtual character other than the target replay character under the current game behavior is determined based on the historical game data of the virtual character other than the target replay character.

Similarly, the gaming level of the virtual character other than the target replay character under the currently determined game behavior may also be determined based on the included gaming level at which each game behavior is executed, e.g., the current game behavior is shooting, and the gaming level is: shooting accuracy of 90%.

In step S203, the virtual character other than the target replay character is controlled to execute the current game behavior in accordance with the gaming level under the current game behavior.

The game behavior of the virtual character other than the target replay character during the replay may be controlled based on the current game behavior and the gaming level under the current game behavior of the virtual character other than the target replay character, herein, the current game behavior and the gaming level under the current game behavior of the virtual character other than the target replay character are determined based on the above.

In some examples, the preset game logic may also be adapted according to the gaming level and operating habits of the virtual character other than the target replay character.

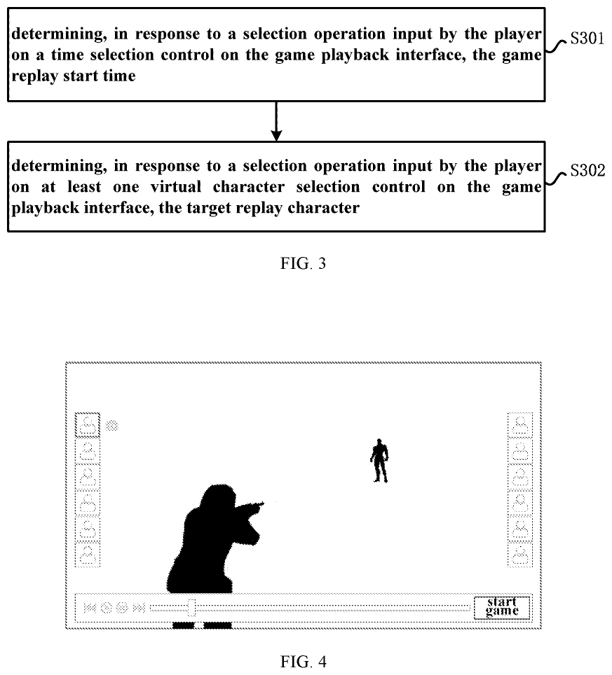

FIG. 3 is a schematic flowchart of yet another game replay control method provided by the embodiments of the present disclosure. As shown in FIG. 3, in the step S101, the determining, in response to the preset selection operation of the player on the game playback interface, the game replay start time and the target replay character includes the following steps S301˜S302.

In step S301, the game replay start time is determined in response to a selection operation input by the player on a time selection control on the game playback interface.

In some embodiments, a time selection control is displayed on the game playback interface, and the player may input on the time selection control the game replay start time that the player wants to replay. The time selection control may be a touch-slide control that allows the time to be adjusted in real-time by being slid up and down. There may be many forms of the time selection control, and there are no specific restrictions in the present disclosure.

In step S302, the target replay character is determined in response to a selection operation input by the player on at least one virtual character selection control on the game playback interface.

Similarly, the virtual character selection control is also displayed on the game playback interface, and the player may switch to select one of the virtual characters as the target replay character by clicking on the virtual character selection control. There are no restrictions on how the virtual character selection control is displayed or how the target replay character is selected.

FIG. 4 is a schematic diagram of a graphical user interface provided by the embodiments of the present disclosure. As shown in FIG. 4, in an implementation, the time selection control described above may be displayed in the form of a progress bar. The player may select the game replay start time by dragging and dropping the progress bar.

Subimages corresponding to each virtual character are displayed on the game playback interface, and the method of the present disclosure further includes: determining, in response to a selection operation instruction of the player on a subimage, that the virtual character corresponding to the subimage is selected as the target replay character.

In this embodiment, the subimages may be a plurality of block diagrams as shown in FIG. 4, and each subimage may display an avatar of one virtual character. In an implementation, the player may make a selection of the target replay character through the subimage, and any virtual character may be determined as the target replay character by being clicked on.

In the step S302 described above, after the determining, in response to the selection operation input by the player on the at least one virtual character selection control on the game playback interface, the target replay character, the method of the present disclosure further includes: determining, based on the target replay character, the game scene corresponding to the target replay character as a viewpoint focus.

As shown in FIG. 4, after the target replay character is selected, a “camera” icon will appear near the corresponding subimage of the target replay character for identification. At this point, the game viewpoint switches to the viewpoint where the target replay character is the focus, and the game scene corresponding to the target replay character as the viewpoint focus is displayed on the game competition interface.

In addition to the “camera” icon, the target replay character may also be identified by other identifiers.

The pre-stored historical game data may include game data of each virtual character, and the game data includes one or more of: location information, a life value, a skill state, or competing level.

In this embodiment, the location information may be the location of each virtual character at each moment in the historical competition, the life value may refer to the blood state, etc., the skill state may refer to the skill being recovered or being available, and the competing level may be a combined output state of the virtual character. The type of the game data may vary depending on the type of the game.

When the game playback interface is switched to the game competition interface, a game footage consistent with the historical competition at that time may be obtained accordingly by performing, based on the game scene generated according to the above game data of each virtual character at the game replay start time, the scene restoration.

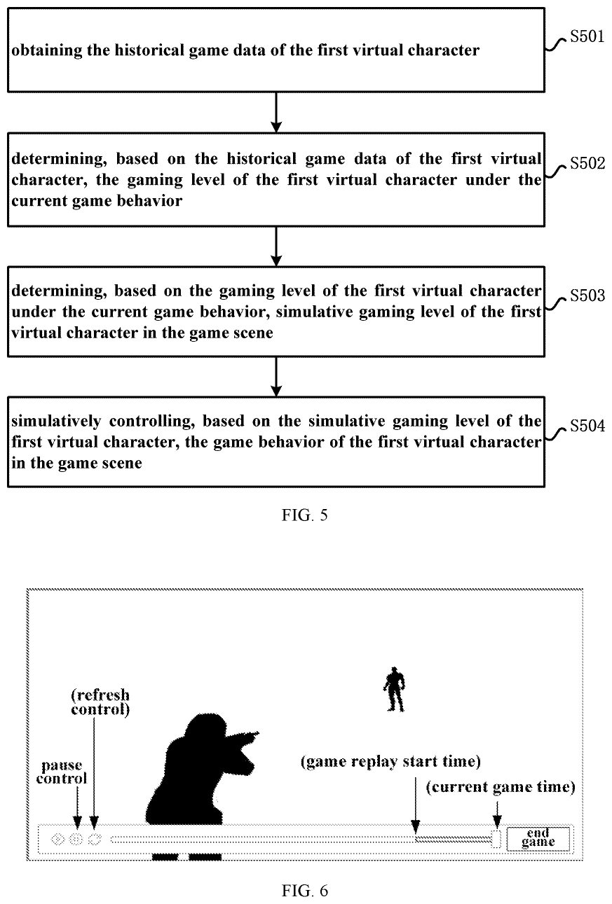

FIG. 5 is a schematic flowchart of another game replay control method provided by the embodiments of the present disclosure. The virtual character includes a first virtual character other than the target replay character. As shown in FIG. 5, the controlling, based on the preset game logic, the game behavior of the virtual character other than the target replay character in the above step S103 may include the following steps S501˜S504.

In step S501, the historical game data of the first virtual character is obtained.

The first virtual character may include, but is not limited to, one virtual character. In some multiplayer role-playing games, the first virtual character may be multiple virtual characters. Regardless of the number of the first virtual character, the control of the game behavior of the first virtual character may be implemented in the same method.

The historical game data of the first virtual character may be obtained from the historical data for that game that is pre-stored in the backend database of the server.

In step S502, the gaming level of the first virtual character under the current game behavior is determined based on the historical game data of the first virtual character.

The game behavior of the first virtual character at different game moments and the gaming level of the first virtual character under the execution of each game behavior may be analyzed and obtained based on the historical game data of the first virtual character.

In step S503, simulative gaming level of the first virtual character in the game scene is determined based on the gaming level of the first virtual character under the current game behavior.

The simulative gaming level of the first virtual character in the restored game scene may be obtained based on the determined gaming level of the first virtual character under the current game behavior, herein, the current game behavior may change sequentially according to the ongoing play of the game.

In step S504, the game behavior of the first virtual character in the game scene is simulatively controlled based on the simulative gaming level of the first virtual character.

In some embodiments, the first virtual character in the game scene may be regarded as a robot controlled by a computer, and the game behavior of the first virtual character is controlled by assigning the simulative gaming level of the first virtual character determined above to the robot.

Taking an attack-type game (a shooting game, or a battle game) as an example, the gaming level described above may include one or more of: attack accuracy, a kill number, or a death number. For a sprint-type game, the gaming level may include: sprinting speed, obstacle avoidance accuracy, etc. The details may vary depending on the game type.

Correspondingly, for the attack-type game described above, the simulative gaming level may include one or more of: an attack discrete value, an attack propensity value, or a defense propensity value.

In some examples, the higher the attack accuracy of the gaming level is, the smaller the attack discrete value of the simulative gaming level is; the larger the kill number of the gaming level is, the larger the attack propensity value of the simulative gaming level is; and the smaller the death number of the gaming level is, the larger the defense propensity value of the simulative gaming level is.

The method of the present disclosure may further include: terminating, in response to a game over control instruction input by the player on the game competition interface, control of the target replay character replaying the game; and switching the game competition interface back to the game playback interface, herein, a playback time corresponds to the game playback interface is the game replay start time.

In some embodiments, as shown in FIG. 4, a game start control is further included on the game playback interface. When the game replay start time and the target replay character are determined, in response to a replay start instruction input by the player on the game start control, the game playback interface may be switched to the game competition interface and the game replay for the target replay character starts.

FIG. 6 is a schematic diagram of another graphical user interface provided by the embodiments of the present disclosure. On the game competition interface, the player may control the game behavior of the target replay character to perform the game replay. A game over control as shown in FIG. 6 may be further included on the game competition interface. In response to the game over control instruction for the replay input by the player on the game over control, the game replay may be terminated, and the game competition interface may be switched back to the game playback interface. The game scene displayed on the game playback interface that is switched back is the game scene at the starting time of the playback before starting the game replay. For example, if a player chooses to replay the game from the 5th minute when watching the playback until the 10th minute, then when the game playback interface is switched back to from the game competition interface, the game playback will be continued from the 10th minute to avoid the missing of the playback for certain scenes and the missing of the replay for certain scenes.

In the step S102 described above, after the switching the game playback interface to the game competition interface, the method of the present disclosure further includes: displaying on the game competition interface a time selection control. In this embodiment, the time selection control includes a game playback time display area and a game replay time display area, the game playback time display area is used for displaying a competition progress of the game before the game replay start time, and the game replay time display area is used for displaying a replay competition progress after the game replay start time.

As shown in FIG. 6, the time selection control is used as a progress bar for explanation. The time display area before the game replay start time marked in the figure is the game playback time display area, and the time display area after the game replay start time is the game replay time display area. That is, the progress bar displayed in light color in the first half of the figure corresponds to the game playback time display area, the progress bar displayed in deepened color in the second half corresponds to the game replay time display area, and the current game time marked is the current game time that is replayed to.

The method of the present disclosure further includes: determining, in response to a selection operation input by the player on the game replay time display area, a new replay time for the target replay character between a current time and the game replay start time.

In some embodiments, to achieve multiple times of practice for some particular moments, a new replay time may be reselected after replaying to any moment when the player wants to practice the competing skill for a certain moment repeatedly.

In this embodiment, the new replay time is a new time selected between the game replay start time and the current game time, i.e., a new time reselected on the game replay time display area. The new replay time also includes the game replay start time used again as the new replay time, thereby achieving multiple times of training for the game replay start time. In response to a sliding operation input by the player on the progress bar on the game replay time display area, the new replay time for the target replay character may be determined, and thus the game scene is switched to the game scene corresponding to the new replay time.

As shown in FIG. 6, the game competition interface further includes a refresh control, and the method of the present disclosure further includes: restarting the replay competition progress by controlling, in response to a refresh operation instruction input by the player on the refresh control, the target replay character to return from a replay game scene at a current time to a replay game scene at the game replay start time.

In some embodiments, to enable the player to quickly return from the game competition at the current game time to the game competition at the game replay start time during the replay through the refresh control, the refresh control is further included on the game competition interface.

The game competition interface may further include: a pause control. The game may be paused in real-time while the player is replaying the game in response to a game pause instruction input by the player on the pause control.

In summary, the game replay control method provided in this embodiment includes: determining, in response to a preset selection operation of a player on the game playback interface, a game replay start time and a target replay character; switching the game playback interface to a game competition interface, and restoring, based on the historical game data, a game scene corresponding to the game replay start time on the game competition interface; and controlling, in response to a target replay character control operation input on the game competition interface, a game behavior of the target replay character, and at a same time, controlling, based on preset game logic, a game behavior of a virtual character other than the target replay character. According to the examples in the present disclosure, the game scene of the target replay character at the game replay start time can be restored in response to the preset selection operation input by the player on the game playback interface, herein, the target replay character is selected by the player, and in response to the control operation input by the player for the target replay character, the game behavior of the target replay character can be controlled in the restored game scene, thereby achieving the game replay. Through the preset selection operation input by the player, the player can replay, in a targeted manner, the game scene and the game character that he is interested in, improving the gaming experience of the player. In addition, during the replay process, by controlling the game behavior of the virtual character other than the target replay character based on the preset game logic, the gaming level of the virtual character other than the target replay character in the historical game competition can be more realistically restored, allowing the player to train the character's reaction ability and operation ability in a specific situation during the replay process of the target replay character, which can help the player to improve the deficiencies and achieve better results in the subsequent gameplay.

In addition, by the determining operation in response to the new replay time input by the player, repeated practice of the player for certain specific moments of the game competition can be achieved, and thus improving the operating skills of the player.

The apparatus, device, and storage medium for executing the game replay control method provided in the present disclosure are described below, and the specific implementation and technical effects thereof are described above and will not be repeated below.

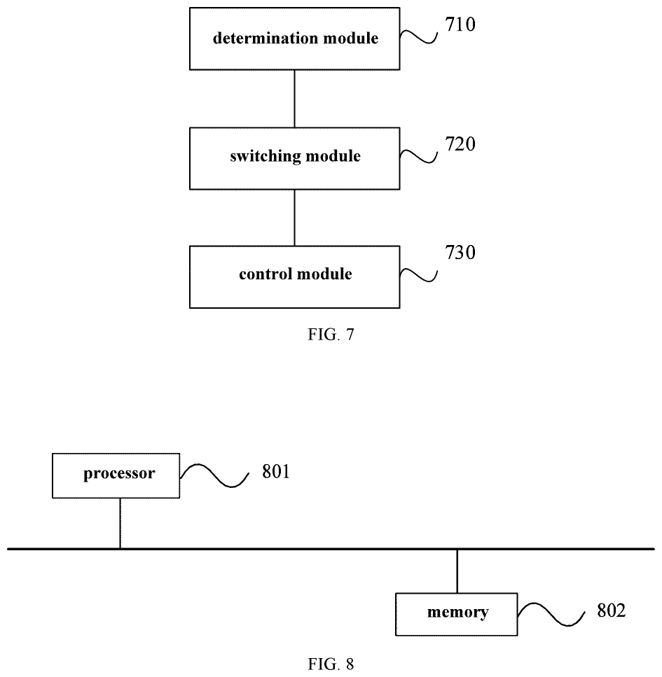

FIG. 7 is a schematic diagram of a game replay control apparatus provided by the embodiments of the present disclosure. The functions implemented by the game replay control apparatus correspond to the execution steps of the above method. The apparatus may be understood as the above terminal device or the server of the terminal device, or a component that is independent of the server or processor described above and implements the functions of the present disclosure under the control of the server.

A graphical user interface is provided on a display of a terminal, a game playback interface is displayed on the graphical user interface, the game playback interface is used for playing back a corresponding gameplay footage based on pre-stored historical game data, and as shown in FIG. 7, the apparatus includes: a determination module 710, a switching module 720, and a control module 730.

The determination module 710 is configured to determine, in response to a preset selection operation of a player on the game playback interface, a game replay start time and a target replay character.

The switching module 720 is configured to switch the game playback interface to a game competition interface, and restore, based on the historical game data, a game scene corresponding to the game replay start time on the game competition interface.

The control module 730 is configured to control, in response to a target replay character control operation input on the game competition interface, a game behavior of the target replay character, and at a same time, control, based on preset game logic, a game behavior of a virtual character other than the target replay character.

In some examples, the preset game logic is artificial intelligence behavior logic, and the artificial intelligence behavior logic is used for controlling an execution order of the game behavior of the virtual character other than the target replay character and gaming level of the virtual character other than the target replay character when executing the game behavior.

In some examples, the control module 730 is specifically configured to: determine, based on the execution order of the game behavior indicated by the artificial intelligence behavior logic, current game behavior of the virtual character other than the target replay character; determine, based on the historical game data of the virtual character other than the target replay character, the gaming level of the virtual character other than the target replay character under the current game behavior; and control the virtual character other than the target replay character to execute the current game behavior in accordance with the gaming level under the current game behavior.

In some examples, the determination module 710 is configured to: determine, in response to a selection operation input by the player on a time selection control on the game playback interface, the game replay start time; and determine, in response to a selection operation input by the player on at least one virtual character selection control on the game playback interface, the target replay character.

In some examples, the determination module 710 is further configured to determine, based on the target replay character, the game scene corresponding to the target replay character as a viewpoint focus.

In some examples, subimages corresponding to each virtual character are displayed on the game playback interface, and the determination module 710 is further configured to determine, in response to a selection operation instruction of the player on a subimage, that the virtual character corresponding to the subimage is selected as the target replay character.

In some examples, the pre-stored historical game data includes game data of each virtual character, and the game data includes one or more of: location information, a life value, a skill state, or competing level.

In some examples, the control module 730 is specifically configured to: obtain the historical game data of the first virtual character; determine, based on the historical game data of the first virtual character, the gaming level of the first virtual character under the current game behavior; determine, based on the gaming level of the first virtual character under the current game behavior, simulative gaming level of the first virtual character in the game scene; and simulatively control, based on the simulative gaming level of the first virtual character, the game behavior of the first virtual character in the game scene.

In some examples, the gaming level includes one or more of: attack accuracy, a kill number, or a death number; and the simulative gaming level includes one or more of: an attack discrete value, an attack propensity value, or a defense propensity value.

In some examples, the higher the attack accuracy of the gaming level is, the smaller the attack discrete value of the simulative gaming level is; the larger the kill number of the gaming level is, the larger the attack propensity value of the simulative gaming level is; and the smaller the death number of the gaming level is, the larger the defense propensity value of the simulative gaming level is.

In some examples, the switching module 720 is further configured to: terminate, in response to a game over control instruction input by the player on the game competition interface, control of the target replay character replaying the game; and switch the game competition interface back to the game playback interface, herein, a playback time corresponds to the game playback interface is the game replay start time.

In some examples, the apparatus further includes a display module.

The display module is configured to display on the game competition interface a time selection control. In this embodiment, the time selection control includes a game playback time display area and a game replay time display area, the game playback time display area is used for displaying a competition progress of the game before the game replay start time, and the game replay time display area is used for displaying a replay competition progress after the game replay start time.

In some examples, the determination module 710 is further configured to determine, in response to a selection operation input by the player on the game replay time display area, a new replay time for the target replay character between a current time and the game replay start time.

In some examples, the game competition interface further includes: a refresh control.

The control module 730 is further configured to restart the replay competition progress by controlling, in response to a refresh operation instruction input by the player on the refresh control, the target replay character to return from a replay game scene at a current time to a replay game scene at the game replay start time.

The above apparatus is used to execute the method provided in the aforementioned embodiments, which is implemented with similar principles and technical effects, and will not be repeated herein.

These above modules described above may be one or more integrated circuits configured to implement the above methods, e.g., one or more application specific integrated circuits (ASICs), or, one or more microprocessors (digital signal processors, referred to as DSPs), or, one or more field programmable gate arrays (FPGA), and so on. For another example, when one of the above modules is implemented in the form of a processing element that dispatches program code, the processing element may be a general-purpose processor, such as a central processing unit (CPU) or other processors that can call the program code. For yet another example, these modules may be integrated together and implemented as a system-on-a-chip (SOC).

The modules described above may be connected or in communication with each other via a wired connection or a wireless connection. Wired connections may include metal cables, fiber optic cables, hybrid cables, etc., or any combination thereof. Wireless connections may include connections in the form of LAN, WAN, Bluetooth, ZigBee, or NFC, or any combination thereof. Two or more modules may be combined into a single module, and any one module may be divided into two or more units. It will be clear to those skilled in the art that, for the convenience and brevity of the description, the specific working processes of the system and apparatus described above may be referred to the corresponding processes in the method embodiments and will not be repeated in the present disclosure.

It is to be noted that these above modules described above may be one or more integrated circuits configured to implement the above methods, e.g., one or more application specific integrated circuits (ASICs), or, one or more microprocessors (digital signal processors, referred to as DSPs), or, one or more field programmable gate arrays (FPGA), and so on. For another example, when one of the above modules is implemented in the form of a processing element that dispatches program code, the processing element may be a general-purpose processor, such as a central processing unit (CPU) or other processors that can call the program code. For yet another example, these modules may be integrated together and implemented as a system-on-a-chip (SOC).

FIG. 8 is a schematic structure diagram of a terminal device provided by the embodiments of the present disclosure. The terminal device may include a processor 801 and a memory 802.

The memory 802 is configured to store a program. The processor 801 calls the program stored in the memory 802 to execute the method embodiments described above. The specific implementations and technical effects are similar and will not be repeated herein.

The present disclosure also provides a program product, such as a non-transitory computer-readable storage medium, including a program. The program, when executed by a processor, is configured to execute the method embodiments described above.

In some examples, the program, when executed by a processor, is configured to: determine, in response to a preset selection operation of a player on the game playback interface, a game replay start time and a target replay character; switch the game playback interface to a game competition interface, and restore, based on the historical game data, a game scene corresponding to the game replay start time on the game competition interface; and control, in response to a target replay character control operation input on the game competition interface, a game behavior of the target replay character, and at a same time, control, based on preset game logic, a game behavior of a virtual character other than the target replay character.

In some examples, the preset game logic is artificial intelligence behavior logic, and the artificial intelligence behavior logic is used for controlling an execution order of the game behavior of the virtual character other than the target replay character and gaming level of the virtual character other than the target replay character when executing the game behavior.

In some examples, the program, when executed by a processor, is specifically configured to: determine, based on the execution order of the game behavior indicated by the artificial intelligence behavior logic, current game behavior of the virtual character other than the target replay character; determine, based on the historical game data of the virtual character other than the target replay character, the gaming level of the virtual character other than the target replay character under the current game behavior; and control the virtual character other than the target replay character to execute the current game behavior in accordance with the gaming level under the current game behavior.

In some examples, the program, when executed by a processor, is specifically configured to: determine, in response to a selection operation input by the player on a time selection control on the game playback interface, the game replay start time; and determine, in response to a selection operation input by the player on at least one virtual character selection control on the game playback interface, the target replay character.

In some examples, the program, when executed by a processor, is further configured to: determine, based on the target replay character, the game scene corresponding to the target replay character as a viewpoint focus.

In some examples, subimages corresponding to each virtual character are displayed on the game playback interface, and the program, when executed by a processor, is further configured to: determine, in response to a selection operation instruction of the player on a subimage, that the virtual character corresponding to the subimage is selected as the target replay character.

In some examples, the pre-stored historical game data includes game data of each virtual character, and the game data includes one or more of: location information, a life value, a skill state, or competing level.

In some examples, the virtual character includes a first virtual character other than the target replay character, and the program, when executed by a processor, is specifically configured to: obtain the historical game data of the first virtual character; determine, based on the historical game data of the first virtual character, the gaming level of the first virtual character under the current game behavior; determine, based on the gaming level of the first virtual character under the current game behavior, simulative gaming level of the first virtual character in the game scene; and simulatively control, based on the simulative gaming level of the first virtual character, the game behavior of the first virtual character in the game scene.

In some examples, the gaming level includes one or more of: attack accuracy, a kill number, or a death number; and the simulative gaming level includes one or more of: an attack discrete value, an attack propensity value, or a defense propensity value.

In some examples, the higher the attack accuracy of the gaming level is, the smaller the attack discrete value of the simulative gaming level is; the larger the kill number of the gaming level is, the larger the attack propensity value of the simulative gaming level is; and the smaller the death number of the gaming level is, the larger the defense propensity value of the simulative gaming level is.

In some examples, the program, when executed by a processor, is further configured to: terminate, in response to a game over control instruction input by the player on the game competition interface, control of the target replay character replaying the game; and switch the game competition interface back to the game playback interface, herein, a playback time corresponds to the game playback interface is the game replay start time.

In some examples, the program, when executed by a processor, is further configured to: display on the game competition interface a time selection control. The time selection control includes a game playback time display area and a game replay time display area, the game playback time display area is used for displaying a competition progress of the game before the game replay start time, and the game replay time display area is used for displaying a replay competition progress after the game replay start time.

In some examples, the program, when executed by a processor, is further configured to: determine, in response to a selection operation input by the player on the game replay time display area, a new replay time for the target replay character between a current time and the game replay start time.

In some examples, the game competition interface further includes: a refresh control, and the program, when executed by a processor, is further configured to: restart the replay competition progress by controlling, in response to a refresh operation instruction input by the player on the refresh control, the target replay character to return from a replay game scene at a current time to a replay game scene at the game replay start time.

The embodiments of the present disclosure provide a game replay control method, where a graphical user interface is provided on a display of a terminal, a game playback interface is displayed on the graphical user interface, the game playback interface is used for playing back a corresponding gameplay footage based on pre-stored historical game data, and the method includes:
determining, in response to a preset selection operation of a player on the game playback interface, a game replay start time and a target replay character;
switching the game playback interface to a game competition interface, and restoring, based on the historical game data, a game scene corresponding to the game replay start time on the game competition interface; and
controlling, in response to a target replay character control operation input on the game competition interface, a game behavior of the target replay character, and at a same time, controlling, based on preset game logic, a game behavior of a virtual character other than the target replay character.

In some examples, the preset game logic is artificial intelligence behavior logic, and the artificial intelligence behavior logic is used for controlling an execution order of the game behavior of the virtual character other than the target replay character and gaming level of the virtual character other than the target replay character when executing the game behavior.

In some examples, the controlling, based on the preset game logic, the game behavior of the virtual character other than the target replay character includes:
determining, based on the execution order of the game behavior indicated by the artificial intelligence behavior logic, current game behavior of the virtual character other than the target replay character;
determining, based on the historical game data of the virtual character other than the target replay character, the gaming level of the virtual character other than the target replay character under the current game behavior; and
controlling the virtual character other than the target replay character to execute the current game behavior in accordance with the gaming level under the current game behavior.

In some examples, the determining, in response to the preset selection operation of the player on the game playback interface, the game replay start time and the target replay character includes:
determining, in response to a selection operation input by the player on a time selection control on the game playback interface, the game replay start time; and
determining, in response to a selection operation input by the player on at least one virtual character selection control on the game playback interface, the target replay character.

In some examples, after the determining, in response to the selection operation input by the player on the at least one virtual character selection control on the game playback interface, the target replay character, the method further includes:
determining, based on the target replay character, the game scene corresponding to the target replay character as a viewpoint focus.

In some examples, subimages corresponding to each virtual character are displayed on the game playback interface, and the method further includes:
determining, in response to a selection operation instruction of the player on a subimage, that the virtual character corresponding to the subimage is selected as the target replay character.

In some examples, the pre-stored historical game data includes game data of each virtual character, and the game data includes one or more of: location information, a life value, a skill state, or competing level.

In some examples, the virtual character includes a first virtual character other than the target replay character, and the controlling, based on the preset game logic, the game behavior of the virtual character other than the target replay character includes:
obtaining the historical game data of the first virtual character;
determining, based on the historical game data of the first virtual character, the gaming level of the first virtual character under the current game behavior;
determining, based on the gaming level of the first virtual character under the current game behavior, simulative gaming level of the first virtual character in the game scene; and
simulatively controlling, based on the simulative gaming level of the first virtual character, the game behavior of the first virtual character in the game scene.

In some examples, the gaming level includes one or more of: attack accuracy, a kill number, or a death number; and
the simulative gaming level includes one or more of: an attack discrete value, an attack propensity value, or a defense propensity value.

In some examples, the higher the attack accuracy of the gaming level is, the smaller the attack discrete value of the simulative gaming level is;
the larger the kill number of the gaming level is, the larger the attack propensity value of the simulative gaming level is; and
the smaller the death number of the gaming level is, the larger the defense propensity value of the simulative gaming level is.

In some examples, the method further includes:
terminating, in response to a game over control instruction input by the player on the game competition interface, control of the target replay character replaying the game;
and switching the game competition interface back to the game playback interface, where a playback time corresponds to the game playback interface is the game replay start time.

In some examples, after the switching the game playback interface to the game competition interface, the method further includes:
displaying on the game competition interface a time selection control, where the time selection control includes a game playback time display area and a game replay time display area, the game playback time display area is used for displaying a competition progress of the game before the game replay start time, and the game replay time display area is used for displaying a replay competition progress after the game replay start time.

In some examples, the method further includes:
determining, in response to a selection operation input by the player on the game replay time display area, a new replay time for the target replay character between a current time and the game replay start time.

In some examples, the game competition interface further includes: a refresh control, and the method further includes:
restarting the replay competition progress by controlling, in response to a refresh operation instruction input by the player on the refresh control, the target replay character to return from a replay game scene at a current time to a replay game scene at the game replay start time.

The embodiments of the present disclosure provide a game replay control apparatus, where a graphical user interface is provided on a display of a terminal, a game playback interface is displayed on the graphical user interface, the game playback interface is used for playing back a corresponding gameplay footage based on pre-stored historical game data, and the apparatus includes: a determination module, a switching module, and a control module.

The determination module is configured to determine, in response to a preset selection operation of a player on the game playback interface, a game replay start time and a target replay character.

The switching module is configured to switch the game playback interface to a game competition interface, and restore, based on the historical game data, a game scene corresponding to the game replay start time on the game competition interface.

The control module is configured to control, in response to a target replay character control operation input on the game competition interface, a game behavior of the target replay character, and at a same time, control, based on preset game logic, a game behavior of a virtual character other than the target replay character.

In some examples, the preset game logic is artificial intelligence behavior logic, and the artificial intelligence behavior logic is used for controlling an execution order of the game behavior of the virtual character other than the target replay character and gaming level of the virtual character other than the target replay character when executing the game behavior.

In some examples, the control module is specifically configured to: determine, based on the execution order of the game behavior indicated by the artificial intelligence behavior logic, current game behavior of the virtual character other than the target replay character; determine, based on the historical game data of the virtual character other than the target replay character, the gaming level of the virtual character other than the target replay character under the current game behavior; and control the virtual character other than the target replay character to execute the current game behavior in accordance with the gaming level under the current game behavior.

In some examples, the determination module is configured to: determine, in response to a selection operation input by the player on a time selection control on the game playback interface, the game replay start time; and determine, in response to a selection operation input by the player on at least one virtual character selection control on the game playback interface, the target replay character.

In some examples, the determination module is further configured to determine, based on the target replay character, the game scene corresponding to the target replay character as a viewpoint focus.

In some examples, subimages corresponding to each virtual character are displayed on the game playback interface, and the determination module is further configured to determine, in response to a selection operation instruction of the player on a subimage, that the virtual character corresponding to the subimage is selected as the target replay character.

In some examples, the pre-stored historical game data includes game data of each virtual character, and the game data includes one or more of: location information, a life value, a skill state, or competing level.

In some examples, the control module is specifically configured to: obtain the historical game data of the first virtual character; determine, based on the historical game data of the first virtual character, the gaming level of the first virtual character under the current game behavior; determine, based on the gaming level of the first virtual character under the current game behavior, simulative gaming level of the first virtual character in the game scene; and simulatively control, based on the simulative gaming level of the first virtual character, the game behavior of the first virtual character in the game scene.

In some examples, the gaming level includes one or more of: attack accuracy, a kill number, or a death number; and the simulative gaming level includes one or more of: an attack discrete value, an attack propensity value, or a defense propensity value.

In some examples, the higher the attack accuracy of the gaming level is, the smaller the attack discrete value of the simulative gaming level is; the larger the kill number of the gaming level is, the larger the attack propensity value of the simulative gaming level is; and the smaller the death number of the gaming level is, the larger the defense propensity value of the simulative gaming level is.

In some examples, the switching module is further configured to: terminate, in response to a game over control instruction input by the player on the game competition interface, control of the target replay character replaying the game; and switch the game competition interface back to the game playback interface, where a playback time corresponds to the game playback interface is the game replay start time.

In some examples, the apparatus further includes a display module.

The display module is configured to display on the game competition interface a time selection control, where the time selection control includes a game playback time display area and a game replay time display area, the game playback time display area is used for displaying a competition progress of the game before the game replay start time, and the game replay time display area is used for displaying a replay competition progress after the game replay start time.

In some examples, the determination module is further configured to determine, in response to a selection operation input by the player on the game replay time display area, a new replay time for the target replay character between a current time and the game replay start time.

In some examples, the game competition interface further includes: a refresh control.

The control module is further configured to restart the replay competition progress by controlling, in response to a refresh operation instruction input by the player on the refresh control, the target replay character to return from a replay game scene at a current time to a replay game scene at the game replay start time.

In several embodiments provided by the present disclosure, it should be understood that the disclosed apparatus and method, may be implemented in other ways. For example, the apparatus embodiments described above are merely schematic, e.g., the division of the units described, which is only a logical functional division, may be divided in other ways when actually implemented, e.g., multiple units or components may be combined or may be integrated into another system, or some features may be ignored, or not implemented. On another point, the mutual coupling or direct coupling or communication connection shown or discussed may be an indirect coupling or communication connection through some interfaces, devices or units, which may be electrical, mechanical or other forms.

The units illustrated as separate components may or may not be physically separated, and the components displayed as units may or may not be physical units, i.e., may be located in one place or may also be distributed to a plurality of network units. Some or all of these units may be selected according to practical needs to achieve the purpose of the solutions of the embodiments of the present disclosure.

Alternatively, each functional unit in various embodiments of the present disclosure may be integrated in a single processing unit, or each unit may be physically present separately, or two or more units may be integrated in a single unit. The above integrated units may be implemented either in the form of hardware or in the form of hardware plus software functional units.

The above integrated unit implemented in the form of a software functional unit may be stored in a computer-readable storage medium. The aforementioned software functional unit stored in a storage medium includes a number of instructions to cause a computer device (which may be a personal computer, server, or network device, etc.) or processor to perform some of the steps of the method described in various embodiments of the present disclosure. The aforementioned storage medium includes various mediums that can store the program code, such as a USB flash drive, mobile hard disk, read-only memory (ROM), random access memory (RAM), disk or CD-ROM.

What is claimed is:

1. A game replay control method, comprising:
determining, by a terminal, in response to a preset selection operation of a player on a game playback interface, a game replay start time and a target replay character, wherein the terminal comprises a display, a graphical user interface is provided on the display of the terminal, the game playback interface is displayed on the graphical user interface, and the game playback interface is configured for playing back a corresponding gameplay footage based on pre-stored historical game data;
switching, by the terminal, the game playback interface to a game competition interface, and restoring, based on the pre-stored historical game data, a game scene corresponding to the game replay start time on the game competition interface;
in response to a control operation input on the game competition interface, controlling, by the terminal, a game behavior of the target replay character; and
controlling, based on preset game logic, a game behavior of a first virtual character, wherein the first virtual character is different from the target replay character.

2. The method according to claim 1, wherein the preset game logic comprises artificial intelligence behavior logic, and the artificial intelligence behavior logic is configured for controlling an execution order of the game behavior of the first virtual character and gaming level of the first virtual character when executing the game behavior.

3. The method according to claim 2, wherein controlling, based on the preset game logic, the game behavior of the first virtual character comprises:
determining, based on the execution order of the game behavior indicated by the artificial intelligence behavior logic, current game behavior of the first virtual character;
determining, based on historical game data of the first virtual character, the gaming level of the first virtual character under the current game behavior; and
controlling the first virtual character to execute the current game behavior in accordance with the gaming level under the current game behavior.

4. The method according to claim 1, wherein determining, in response to the preset selection operation of the player on the game playback interface, the game replay start time and the target replay character comprises:
determining, in response to a selection operation input by the player on a time selection control on the game playback interface, the game replay start time; and
determining, in response to a selection operation input by the player on a virtual character selection control on the game playback interface, the target replay character.

5. The method according to claim 4, further comprising:
determining, based on the target replay character determined in response to the selection operation, the game scene corresponding to the target replay character as a viewpoint focus.

6. The method according to claim 1, wherein images corresponding to the target replay character and the first virtual character are displayed on the game playback interface, and the method further comprises:
determining the target replay character in response to a selection operation of the player on an image corresponding to the target replay character.

7. The method according to claim 1, wherein the pre-stored historical game data comprises game data of each virtual character, and the game data comprises one or more of: location information, a life value, a skill state, or gaming level.

8. The method according to claim 3, wherein controlling, based on the preset game logic, the game behavior of the first virtual character comprises:
obtaining the historical game data of the first virtual character;
determining, based on the historical game data of the first virtual character, the gaming level of the first virtual character under the current game behavior;
determining, based on the gaming level of the first virtual character under the current game behavior, simulative gaming level of the first virtual character in the game scene; and
simulatively controlling, based on the simulative gaming level of the first virtual character, the game behavior of the first virtual character in the game scene.

9. The method according to claim 8, wherein the gaming level comprises one or more of: attack accuracy, a kill number, or a death number; and
wherein the simulative gaming level comprises one or more of: an attack discrete value, an attack propensity value, or a defense propensity value.

10. The method according to claim 9, wherein
the higher the attack accuracy is, the smaller the attack discrete value is;
the larger the kill number is, the larger the attack propensity value is; and
the smaller the death number is, the larger the defense propensity value is.

11. The method according to claim 1, further comprising:
terminating, in response to a game over control instruction input by the player on the game competition interface, control of the target replay character replaying the game; and switching the game competition interface back to the game playback interface, wherein a playback time corresponds to the game playback interface is the game replay start time.

12. The method according to claim 1, further comprising:
displaying a time selection control on the game competition interface, wherein the time selection control comprises a first display area and a second display area, the first display area is configured for displaying a competition progress of the game before the game replay start time, and the second display area is configured for displaying a replay competition progress after the game replay start time.

13. The method according to claim 12, further comprising:
determining, in response to a selection operation input by the player on the second display area, a new replay time for the target replay character between a current time and the game replay start time.

14. The method according to claim 12, wherein the game competition interface further comprises: a refresh control, and the method further comprises:
restarting the replay competition progress by controlling, in response to a refresh operation input by the player on the refresh control, the target replay character to return from a replay game scene at a current time to a replay game scene at the game replay start time.

15. A terminal device, comprising: a display, a processor, a storage medium and a bus, wherein the storage medium stores program instructions executable by the processor, when the terminal device is running, the processor communicates with the storage medium via the bus, and the processor, through executing the program instructions, is configured to:
determine, in response to a preset selection operation of a player on a game playback interface, a game replay start time and a target replay character, wherein a graphical user interface is provided on the display, the game playback interface is displayed on the graphical user interface, and the game playback interface is configured for playing back a corresponding gameplay footage based on pre-stored historical game data;
switch the game playback interface to a game competition interface, and restore, based on the pre-stored historical game data, a game scene corresponding to the game replay start time on the game competition interface; and
control, in response to a control operation input on the game competition interface, a game behavior of the target replay character, and control, based on preset game logic, a game behavior of a first virtual character, wherein the first virtual character is different from the target replay character.

16. The terminal device according to claim 15, wherein the preset game logic comprises artificial intelligence behavior logic, the artificial intelligence behavior logic is configured for controlling an execution order of the game behavior of the first virtual character and gaming level of the first virtual character when executing the game behavior, and the processor is specifically configured to:
determine, based on the execution order of the game behavior indicated by the artificial intelligence behavior logic, current game behavior of the first virtual character;
determine, based on historical game data of the first virtual character, the gaming level of the first virtual character under the current game behavior; and
control the first virtual character to execute the current game behavior in accordance with the gaming level under the current game behavior.

17. The terminal device according to claim 15, wherein the processor is specifically configured to:
determine, in response to a selection operation input by the player on a time selection control on the game playback interface, the game replay start time; and
determine, in response to a selection operation input by the player on a virtual character selection control on the game playback interface, the target replay character.

18. A non-transitory computer-readable storage medium, wherein the storage medium stores a computer program, and the computer program, when executed by a processor, is configured to:
determine, in response to a preset selection operation of a player on a game playback interface, a game replay start time and a target replay character, wherein a graphical user interface is provided on a display of a terminal, the game playback interface is displayed on the graphical user interface, and the game playback interface is configured for playing back a corresponding gameplay footage based on pre-stored historical game data;
switch the game playback interface to a game competition interface, and restore, based on the pre-stored historical game data, a game scene corresponding to the game replay start time on the game competition interface; and
control, in response to a control operation input on the game competition interface, a game behavior of the target replay character, and control, based on preset game logic, a game behavior of a first virtual character, wherein the first virtual character is different from the target replay character.

19. The storage medium according to claim 18, wherein the preset game logic comprises artificial intelligence behavior logic, the artificial intelligence behavior logic is configured for controlling an execution order of the game behavior of the first virtual character and gaming level of the first virtual character when executing the game behavior, and the processor is specifically configured to:
determine, based on the execution order of the game behavior indicated by the artificial intelligence behavior logic, current game behavior of the first virtual character;
determine, based on historical game data of the first virtual character, the gaming level of the first virtual character under the current game behavior; and
control the first virtual character to execute the current game behavior in accordance with the gaming level under the current game behavior.

20. The storage medium according to claim 19, wherein the processor is specifically configured to:
determine, in response to a selection operation input by the player on a time selection control on the game playback interface, the game replay start time; and
determine, in response to a selection operation input by the player on a virtual character selection control on the game playback interface, the target replay character.
